(19) United States
(12) Patent Application Publication
(10) Pub. No.: US 2012/0056141 A1
(43) Pub. Date: Mar. 8, 2012

(54) HINGED SPORTS POST OR GOAL POST RAISING AND LOWERING DEVICE

(75) Inventors: TIMOTHY ADAM DRISCOLL, DEVON, PA (US); TIMOTHY WARREN DRISCOLL, DEVON, PA (US); GIOVANNI DIVALERIO, KING OF PRUSSIA, PA (US)

(73) Assignee: ALUMINUM ATHLETIC EQUIPMENT COMPANY, ROYERSFORD, PA (US)

(21) Appl. No.: 13/221,228

(22) Filed: Aug. 30, 2011

Related U.S. Application Data
(60) Provisional application No. 61/378,419, filed on Aug. 31, 2010.

(51) Int. Cl. B66D 1/60; A63B 63/04; B66D 1/12

(52) U.S. Cl. 254/362; 254/266; 473/476

(57) ABSTRACT

A device for raising and lowering a hinged sports post or goal post is provided. The device includes a frame with a ground engaging member and an upwardly extending post. Wheels are connected to a medial portion of the frame, and the wheels are adapted to be out of ground contact when the ground engaging member is in an operating position. A winch it is connected on an opposite end of the frame from the ground engaging member. A controller is connected to the winch and is operable by a user in order to raise or lower the hinged post that is connected to the winch cable.

### BACKGROUND

The present invention is directed generally to a device for raising and lowering a hinged sports post or goal post, such as a football goal post, hammer cage poles and gates, backstop netting poles and other generally vertically installed posts or poles which have a hinged connected at the base so that they can be raised and/or lowered for installation, service and/or removal.

There are various pieces of sports equipment that are anchored to the ground and which must be raised and/or lowered for installation and service. Items such as football goal posts, soccer goal posts, hammer cage poles and gates as well as poles used in various backstop systems are often provided with a hinged base which is connected to a ground anchor which allow these various types of sports posts or goal posts to be more easily installed and raised and/or lowered for service and removal as necessary by allowing the various types of posts to be installed while laying on the ground and then be pivoted to an upright position about the hinged connection at the ground anchor. The post is then locked in the upright position through a catch, bolt or other type of connection that must then be removed in order to again lower the post for service and/or removal. Typically, such hinged sports posts or goal posts are raised or lowered by ropes connected to a tractor or through brute force of several individuals pushing on the posts in order to raise it or holding it from falling when it is being lowered. Additionally, depending upon the weight, lowering the post can become a safety issue if it is attempted manually.

It would be desirable to provide a device which can be used to safely raise and/or lower hinged sports posts or goal posts.

### SUMMARY

Briefly stated, a first embodiment of the present invention is directed to a device for raising and lowering a hinged sports post or goal post. The device includes a frame with a ground engaging member and an upwardly extending post. Wheels are connected to a medial portion of the frame, and the wheels are adapted to be out of ground contact when the ground engaging member is in an operating position. A winch it is connected on an opposite end of the frame from the ground engaging member. A controller is connected to the winch and is operable by a user in order to raise or lower the hinged post that is connected to the winch cable.

In another aspect of the invention, the ground engaging member includes base engaging channels having openings that are adapted to be aligned with anchor bolts for the hinged sports post or goal post. Alternatively, the ground engaging member may be an extension of the post that extends downwardly that is adapted to be received in a separate ground sleeve.

Further, in order to make the device according to the invention portable, preferably a battery is mounted in a battery holder on the frame, with the battery being connected to the controller and the winch so that the device is self-powered.

Further, it is preferred if the device according to the invention includes a handle located on the frame at the opposite end from the ground engaging member. When the ground engaging member is disengaged, the device according to the invention can be dropped onto the wheels and pulled via the handle by an operator in an easy and convenient matter.

In a further aspect of the invention, a method for raising, lowering or raising and lowering a hinged sports post or goal post is provided. The method includes providing the device according to the invention, connecting the ground engaging member to a ground anchor for the hinged sports post or goal post or adjacent thereto, connecting a winch cable from the winch to the hinged sports post or goal post, and, with a hinge of the hinged sports post or goal post in a released position, powering the winch to either raise the sports post or goal post from a lowered position to an upright position or lower the sports post or goal posts from an upright position to a lowered position for service or removal.

### BRIEF DESCRIPTION OF THE DRAWINGS

The foregoing summary, as well as the following detailed description of the preferred embodiment of the present invention, will be better understood when read in conjunction with the appended drawings. For the purpose of illustrating the invention, there are shown in the drawings an embodiment which is presently preferred. It is understood, however, that the invention is not limited to the precise arrangement and instrumentality shown. In the drawings:

FIG. 1 is a perspective view of a device for raising or lowering a hinged sports post or goal post according to the invention.

FIG. 2 is a side elevational view of the device shown in FIG. 1.

FIG. 3 is a front elevational view of the device in FIG. 1.

FIG. 4 is a top view showing the device according to the invention with the ground engaging member connected to anchor bolts used to anchor the hinged sports post or goal post.

FIG. 5 is a partial cross-sectional view through the device shown in FIG. 4 showing the connection of the ground engaging member to the anchor bolts for the hinged sports post or goal post.

FIG. 6 is a perspective view showing the device according to the invention in the operating position with the ground engaging member connected at the base of a hinged sports post or goal post, and the goal post being shown in an upright, installed position.

FIG. 7 is a view similar to FIG. 6 showing the goal post in a lowered position, pivoted about the hinge located at the base.

FIG. 8 is a view of an alternate embodiment of the device according to the invention for raising or lowering a hinged sports post or goal post in which the ground engaging member is an extension of the post that extends downwardly and is shown inserted in a separate ground sleeve located adjacent to the anchor for the hinged sports post or goal post.

### DETAILED DESCRIPTION OF THE PREFERRED EMBODIMENTS

Certain terminology is used in the following description for convenience only and is not limiting. The words “right”, left”, “top” and “bottom” designate directions in the drawings to which reference is made. The words “inwardly” and “outwardly” refer to directions toward and away from, respectively the geometric center of the device for raising and lowering hinged sports posts or goals and designated parts thereof. The words “a” and “one”, as used in the claims and in the corresponding portions of the specification, are defined as including one or more of the referenced item unless specifically stated otherwise. This terminology includes the words above specifically mentioned, derivatives thereof, and words of similar import.

Referring to FIGS. 1-4, a device for raising and lowering a hinged sports post or goal post, hereinafter referred to as “the device 10,” is shown in detail. The device 10 includes a frame 20 with a ground engaging member 21 and an upwardly extending post 22. In the first preferred embodiment, the ground engaging member comprises a rear rail 23 connected to the bottom of the center post 22 and to base engaging channels 24 connected at either ends of the rear rail 23. While channels are illustrated, those skilled in the art will recognize that flat plates or angle stock could be used. Side braces 25 extend from the rear rail 23 to the center post 22 to provide additional stability and support. Additionally, side supports 26 extend from a medial portion of the base engaging channels 24 to a cross rail 27 connected at a medial position on the center post 22. Wheel supports 28 are connected to the frame assembly 20, preferably to the center post 22 and to the side supports 26, such that one wheel 36 is located on each side of the center post 22. Preferably, the frame assembly 20 is made of steel and is a welded assembly with the center post being a hollow steel tube, the rear rail 23 and base engaging channels 24 being C-shaped channels, the side braces 25, side supports 26 and the cross rail 27 being angular or tubular steel. While a welded frame assembly 20 is preferred, it is also possible that the frame assembly 20 could be constructed using various other types of fastener, such as screws, bolts, rivets, adhesives, etc.

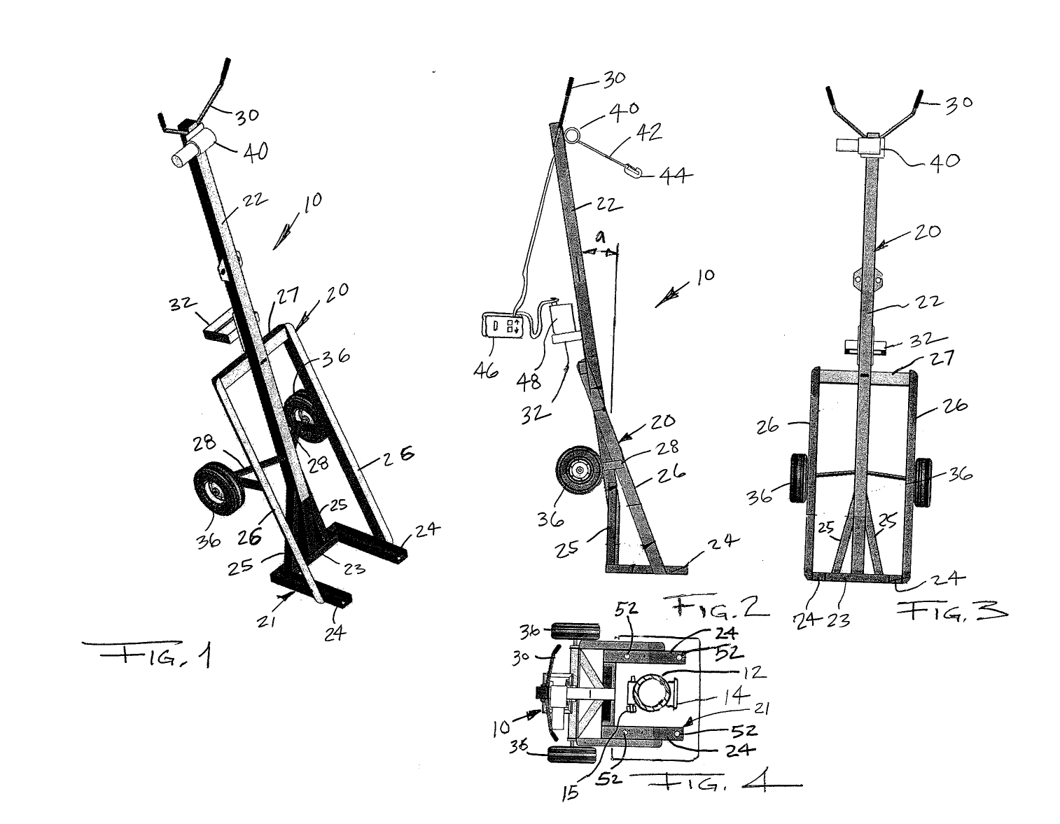

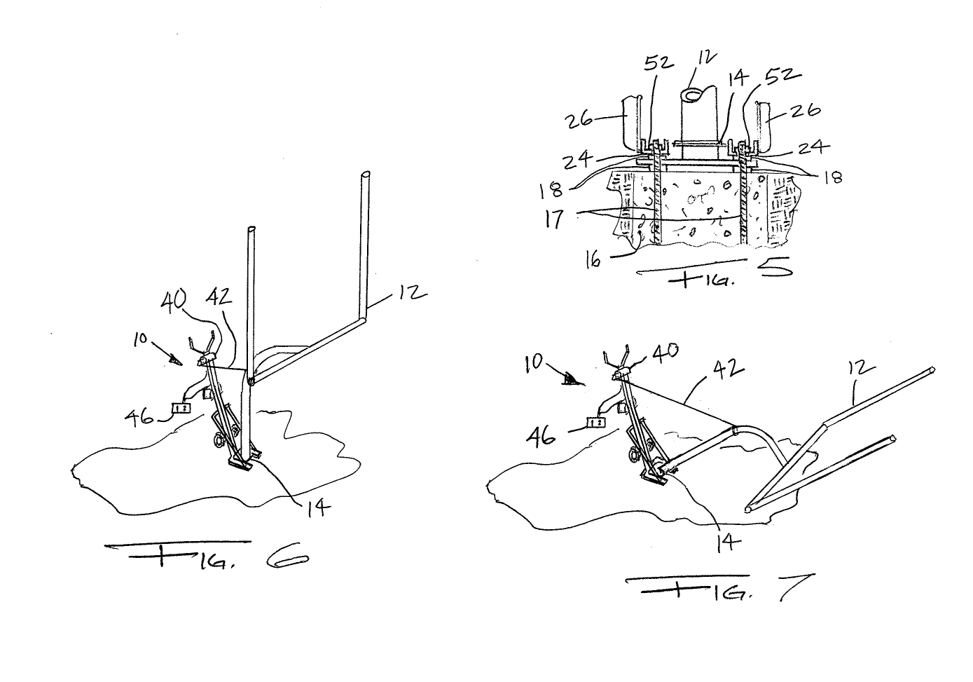

In the preferred embodiment, the center post 22 is set at an angle A of about 10° from vertical. Overall, it is preferred that the center post is approximately 8-10 feet long. The base engaging channels 24 are preferably spaced apart by approximately 15 inches and include holes 52, shown in FIG. 4, which are arranged to match a hole pattern of the anchor bolts used to hold the sports post or goal post to a ground anchor, as explained in further detail below. Alternatively, the holes 52 could be elongated slots or multiple hole patterns could be provided in oversized plates used in place of the base engaging channels 24.

Further, it is preferred that the wheels 36 are adapted to be out of ground contact when the ground engaging member 21 is in an operating position. FIGS. 1-3 show the ground engaging member in the operating position with the wheels 36 out of contact with the ground. Further, a handle 30 is connected to the frame assembly 20 at an opposite end from the ground engaging member 21 such that the entire device 10 can be tipped downwardly from the position shown in FIGS. 1-3 such that the wheels 36 rest on the ground and the device can be moved by an individual using the handles.

As shown in detail in FIGS. 1-3, a winch 40 is connected to the frame assembly 22 at an opposite end from the ground engaging member 21. The winch 40 includes a winch cable 42 and preferably a hook 44 located on the end thereof which can be used to either wrap around a sports post or goal post or can be connected to an eye located on the sports post or goal post to assist in raising or lowering it into or out of an upright position.

A controller 46 is connected to the winch 40 and includes user controls which allow the winch 40 to either reel in or reel out the cable 42. A battery holder 30 is connected to the frame assembly 22. A battery 48 is located in and preferably strapped to the battery holder 32 in order to allow the device 10 to be portable and not need an external source of power. The battery 48 is electrically connected to the controller 46 and the winch 40 via cables as shown in FIG. 2.

In order to use the device 10 according to the invention, the ground engaging member 21 must be connected to the bolts 17 extending from the anchor 16 for the sports post or goal post 12. This is shown in FIG. 5 for the first embodiment where the base engaging channels 24 of the ground engaging member 21 have been positioned on the bolts 17 extending from the anchor 16. Here, the nuts 18 which are used to connect the base of the post 12 to the anchor bolts 17 are shown, with one nut 18 located on each side of the base plate for the post 12 at each bolt 17 to allow for leveling of the post 12. The openings 52 in the base engaging channels 24 are aligned with the bolts 17 which extend upwardly from the anchor 16, resulting in the center post 12 extending generally upwardly, preferably at the angle α from vertical. Nuts 52 are then used to fix the ground engaging member 21 in position at the base of the post 12. The angle α is preferably in the range of 5° to 20°, and more preferably about 10°.

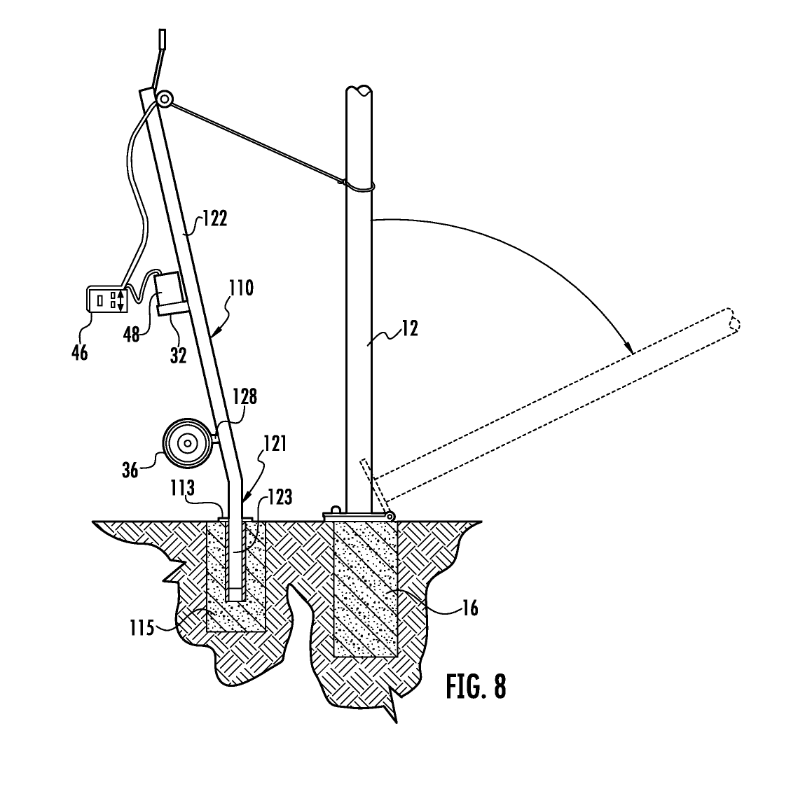

As shown in FIGS. 6 and 7, in order to lower the post 12, such as a football goal post as shown, from its installed position, the hinge catch of the hinge 14, which can be a pin such as the pin 15 shown in FIG. 4, is removed or released in order to release the hinge 14 after the device 10 has been positioned and the cable 42 has been connected to the post 12. The user then uses the controller 46 to power the winch 40 to lower the post 12 to the position shown in FIG. 7 for service and/or removal. Additionally, in order to install and raise a hinged sports post or goal post 12 from the lowered position shown in FIG. 7 to an upright position as shown in FIG. 6, the ground engaging member 21 is connected to the base of the post 12 in the same manner discussed above. The winch cable 42 is connected to the post 12 and the user operates the controller 46 so that the winch 40 reels in the cable 42 and raises the sports post or goal post 12 to an upright position where the hinge catch, such as a the catch pin 15, can be reinserted in order to hold the post 12 in its upright position for use.

Referring to FIG. 8, an alternate embodiment of the device 110 is shown. Device 110 is similar to the device 10 as noted above except that the ground engaging member 121 comprises an extension 123 of the post 122 that extends further downwardly. This is adapted to be engaged in a ground sleeve 113 which may be installed adjacent to the anchor 16 for the sports post or goal post 12. Alternatively, it can be installed at the same time as the anchor 16 for sports post or goal post 12 by placing the ground sleeve 113 in an enlarged cement base at the same time the J-bolts 17 are installed that are used to hold the goal post or sports post 12 in position. The device 110 operates in the same manner as the device 10 and eliminates the need for having aligned holes and the requirement to connect the ground engaging member 21 of the first embodiment to the base of an existing sports post or goal post thus allowing for easy retrofit installations of ground sleeves 113 so that the device 110 according to the invention can be used.

Both embodiments of the device for raising an lowering a hinged sports post or goal post provide an easy, convenient and portable assembly that can be easily moved by a single user into position and can more safely raise or lower a hinged goal post or sports post 12 than the prior known methods.

It is understood, therefore, that this invention is not limited to the particular embodiment disclosed, but is intended to cover all modifications which are within the spirit and scope of the invention as defined by the amended claims and/or shown in the attached drawings.

What is claimed is:

1. A device for raising and lowering a hinged sports post or goal post, comprising:
a frame with a ground engaging member and an upwardly extending post;
wheels connected to a medial portion of the frame, the wheels being adapted to be out of ground contact when the ground engaging member is in an operating position;
a winch connected to an opposite end of the frame from the ground engaging member; and
a controller connected to the winch.

2. The device of claim 1, wherein the ground engaging member comprises base engaging channels having openings that are adapted to be aligned with anchor bolts for the hinged sport post or goal post.

3. The device of claim 1, further comprising a battery holder connected to the frame, and a battery in the battery holder, the battery being electrically connected to the controller and the winch.

4. The device of claim 1, further comprising a handle located on the frame at the opposite end from the ground engaging member.

5. The device of claim 1, wherein the ground engaging member is an extension of the post that extends downwardly.

6. A method of raising, lowering or raising and lowering a hinged sports post or goal post, comprising:
providing a device for raising and lowering hinged sports post or goal post, including a frame with a ground engaging member and an upwardly extending post, wheels connected to a medial portion of the frame, the wheels being adapted to be out of ground contact when the ground engaging member is in an operating position, a winch connected to an opposite end of the frame from the ground engaging member, and a controller connected to the winch;
connecting the ground engaging member to a ground anchor for the hinged sports post or goal post or adjacent thereto;
connecting a winch cable from the winch to the hinged sports post or goal post; and
with a hinge catch of the hinged sports post or goal post in an unlatched position, powering the winch to either raise the sports post or goal post from a lowered position to an upright position or lower the sports post or goal post from an upright position to a lowered position for service or removal.
